(19) United States
(12) Patent Application Publication
(10) Pub. No.: US 2009/0144986 A1
(43) Pub. Date: Jun. 11, 2009

(54) FOLDING KNIFE

(76) Inventor: Spencer Frazer, Lynnwood, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/952,815

(22) Filed: Dec. 7, 2007

(51) Int. Cl. B26B 1/04

(52) U.S. Cl. 30/159; 30/155; 30/160

(57) ABSTRACT

A biasing system for the blade of a folding knife includes one component or assembly applying a force tending to move the knife blade from a closed position, nested in the handle, to an open position, extending from the handle. A second component or assembly resists opening of the blade, particularly when the blade is in or near the closed position. The resisting force is overcome by the opening force after the blade has been moved through a predetermined angle relative to the handle, so that the blade then opens automatically. A safety can be actuated to block opening and/or closing of the blade. The blade can have a blunt projection upon which a user may press to move the blade through the predetermined opening angle. A clip can be provided for convenient attachment of the folding knife to an object such as a garment.

### RELATED APPLICATIONS

This application claims priority benefit of U.S. Ser. No. 11/045,866 filed Jan. 8, 2005, U.S. Ser. No. 10/217,340 filed Aug. 8, 2002, now U.S. Pat. No. 6,941,661, U.S. Ser. No. 60/353,791 filed Jan. 31, 2002, and U.S. Ser. No. 60/310,941 filed Aug. 8, 2001.

### BACKGROUND OF THE DISCLOSURE

This invention relates to knives and, more specifically, to a folding knife with a biasing system for the blade to assist in moving the blade toward an open position, and to a knife having a novel clip for convenient attachment to an object such as a garment.

Known folding knives have a blade pivoted to a handle. The blade is moveable between an open position in which a sharpened edge of the blade is exposed for use, with the blade projecting from the handle, and a “closed” position in which the sharpened edge of the blade is received in a channel in the handle. Different mechanisms have been provided to move the blade from the closed position to the open position. An example is the system shown in U.S. Pat. No. 5,802,722, which is expressly incorporated by reference herein. See also the “prior art” referred to in U.S. Pat. No. 5,802,722.

### BRIEF DESCRIPTION OF THE DRAWINGS

FIG. 1 is a side elevation of a folding knife with opening assist in accordance with the present invention, the blade of the knife being shown in the open position;

FIG. 2 is a top plan of the knife of FIG. 1;

FIG. 3 is a side elevation corresponding to FIG. 1 with parts broken away to reveal internal components; and

FIGS. 4 and 5 are side elevations corresponding to FIG. 3, with the same parts broken away but with parts in different positions, FIG. 4 showing an intermediate position of the blade and FIG. 5 showing the closed position of the blade;

FIG. 6 is a somewhat diagrammatic side elevation of a second embodiment of a folding knife with opening assist in accordance with the present invention, with parts broken away to reveal internal components of the knife, showing the closed position of the blade;

FIG. 7 is a side elevation corresponding to FIG. 6 but with the blade moved toward the open position;

FIG. 8 is a side elevation corresponding to FIGS. 6 and 7 but with the blade moved farther toward the open position;

FIG. 9 is a side elevation corresponding to FIGS. 6-8 but with the blade moved farther toward the open position; and

FIG. 10 is a side elevation corresponding to FIGS. 6-9 but with the blade in the open position;

FIG. 11 is a somewhat diagrammatic side elevation of a third embodiment of a folding knife with opening assist in accordance with the present invention, with parts broken away to reveal internal components of the knife, and with blade of the folding knife in the closed position;

FIG. 12 is a side elevation corresponding to FIG. 11 but with the blade moved part way toward the open position; and

FIG. 13 is a side elevation corresponding to FIGS. 11 and 12 but with the blade moved to the open position;

FIG. 14 is a somewhat diagrammatic side elevation of a fourth embodiment of a folding knife with opening assist in accordance with the present invention, with parts broken away to reveal internal components of the knife, and with the blade of the folding knife in the closed position;

FIG. 15 is a side elevation corresponding to FIG. 14 but with the blade moved toward the open position;

FIG. 16 is a side elevation corresponding to FIGS. 14 and 15 but with the blade moved farther toward the open position;

FIG. 17 is a side elevation corresponding to FIGS. 14-16 but with the blade moved farther toward the open position; and

FIG. 18 is a side corresponding to FIGS. 14-17 but with the blade in the open position.

FIG. 19 is a side elevation of a knife having a attachment clip in accordance with the present invention, and

FIG. 20 is a fragmentary section thereof taken along line 20-20 of FIG. 19;

FIG. 21 is a somewhat diagrammatic side elevation of another embodiment of a folding knife with opening assist in accordance with the present invention, with parts broken away to reveal internal components of the knife, and with the blade of the folding knife in the closed position;

FIG. 22 is a side elevation corresponding to FIG. 21 but with the blade moved toward the open position; and

FIG. 23 is a side elevation corresponding to FIGS. 21 and 22 but with the blade in the open position;

FIG. 24 is a somewhat diagrammatic side elevation of another embodiment of a folding knife with opening assist in accordance with the present invention, with parts broken away to reveal internal components of the knife, and with the blade of the folding knife in the closed position; and

FIG. 25 is a side elevation corresponding to FIG. 24 but with the blade in the open position;

FIG. 26 is a somewhat diagrammatic side elevation of another embodiment of a folding knife with opening assist in accordance with the present invention, with parts broken away to reveal internal components of the knife, and with the blade in the closed position; and

FIG. 27 is a side elevation corresponding to FIG. 26 with the blade in the open position;

FIG. 28 is a somewhat diagrammatic side elevation of another embodiment of a folding knife with opening assist in accordance with the present invention, with parts broken away to reveal internal components of the knife, with the blade of the folding knife in the closed position;

FIG. 29 is a side elevation corresponding to FIG. 27 but with the blade in the open position; and

FIG. 30 is an enlarged fragmentary section along line 30-30 of FIG. 29;

FIG. 31 is a somewhat diagrammatic side elevation of another embodiment of a folding knife with opening assist in accordance with the present invention, with parts broken away to reveal internal components of the knife, and with the blade in the closed position;

FIG. 32 is a side elevation corresponding to FIG. 31 but with the blade moved toward the open position;

FIG. 33 is a side elevation corresponding to FIGS. 31 and 32 but with the blade in the open position;

FIG. 34 is a somewhat diagrammatic top plan of the knife of FIGS. 31-33 with the blade in the open position; and

FIG. 35 is a top perspective of a component of the knife of FIGS. 31-34;

FIG. 36 is a somewhat diagrammatic side elevation of another embodiment of a folding knife with opening assist in accordance with the present invention, the blade of the knife being shown in the open position;

FIG. 37 is a somewhat diagrammatic side elevation corresponding to FIG. 36, with some parts broken away to reveal internal components;

FIG. 38 is a side elevation corresponding to FIG. 37 but with the blade moved toward the closed position; and

FIG. 39 is a side elevation corresponding to FIGS. 37 and 38 but with the blade in the closed position.

### DESCRIPTION OF THE PREFERRED EMBODIMENTS

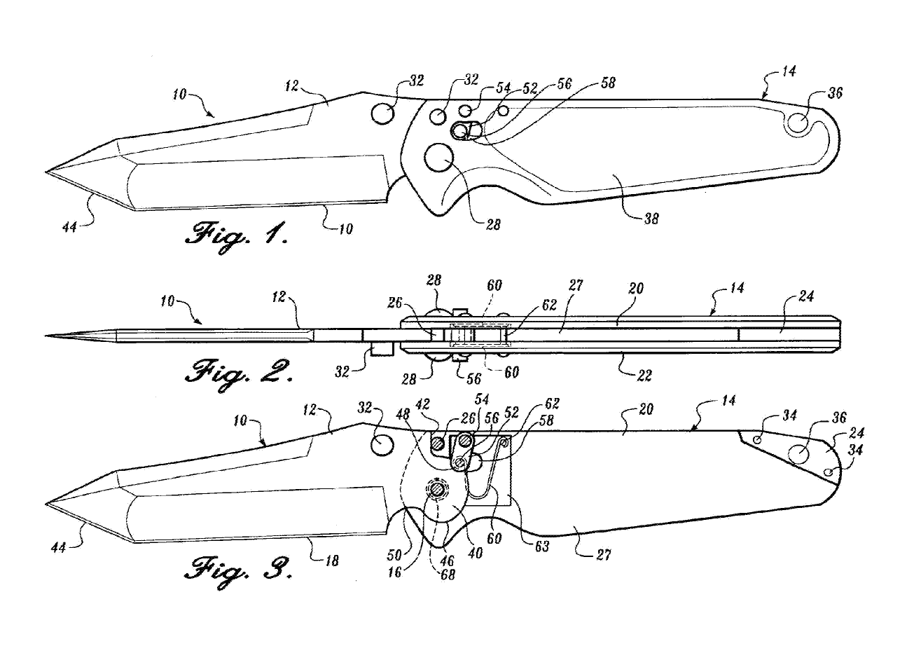

With reference to FIGS. 1-5, a folding knife 10 of the type with which the present invention is concerned has an elongated blade 12 attached to one end portion of a handle 14 by a pivot pin 16 (seen in FIGS. 3-5). As described in more detail below, the blade 12 is swingable relative to the handle between the open or working position shown in FIGS. 1-3, in which the blade extends from the handle with its sharpened edge 18 exposed for use, and a closed position shown in FIG. 5 in which the blade, or at least its sharpened edge portion, is received in the handle. In one aspect of the present invention, an improved mechanism is provided to assist moving the blade to the open position, such as after the blade has been manually moved through a predetermined angle from the closed position.

A typical handle 14 can be formed of several pieces. The handle can include opposite side plates 20, 22 with a rear spacer 24 between them. At the front end of the handle, adjacent to the blade, a stop pin 26 extends between the side plates. The side plates are spaced apart uniformly, forming a groove or channel 27 therebetween of a width slightly greater than the maximum width of the knife blade, for receiving the knife blade in the channel between the handle side plates when the blade is in the closed position.

The blade pivot 16 can include outer portions 28 of a diameter greater than the central blade-carrying portion. The blade swings on the central pin portion between the open position (FIG. 3) and the closed position (FIG. 5). The blade can have a transversely projecting thumb pin or bob 32 near its pivoted end. The pin or bob can be used to manipulate the blade when moving it from the closed position toward the open position, or finger notches or other conventional blade modifications or shapes can be provided for starting to open the knife.

The side plates 20, 22 and spacer 24 can be held together by rivets or screws 34 with a through aperture 36 for attachment of the knife handle to a hook or key chain. The pivot pin 16 and stop pin 26 can be stationarily affixed to the side plates, or one or more of pins 26, 16 can have cooperating threaded parts, as is conventional, which allow the blade to be separated from the handle for replacement or cleaning. The side plates can have contoured portions 38 (FIG. 1) for a comfortable grip. The tang portion 40 of the knife blade, at its butt end adjacent to the knife pivot 16, can have a flattened segment 42 extending generally radially relative to the swinging axis of the blade for engaging the stop pin 26 to limit opening of the knife blade 12 relative to the handle 14. The extent of closing of the knife can be determined by the shape and positioning of the spacer 24 relative to the tapered leading end 44 of the knife blade, as seen in FIG. 5.

In the embodiment illustrated in FIGS. 1-5, the rearwardmost portion of the tang 40 of the blade forms a generally semicircular cam edge 46. Such edge extends from close to the flattened stop portion 42 adjacent to the top of the blade to the bottom portion adjacent to the sharpened edge 18 of the blade. The cam edge 46 has notches or contoured recesses 48 and 50 which cooperate with a mechanical member in the form of an upright locking lever or link 52 as described below.

Link 52 has its upper end portion journaled on a pivot pin 54 extending transversely between the side plates 20 and 22, at the side of the handle opposite the opening through which the blade swings. From an upright position, the bottom end of the link can swing fore and aft through a small acute angle relative to vertical. Actuating buttons 56 project transversely from the bottom or swinging end portion of the link 52 through elongated slots 58 (FIG. 1 and FIG. 3) in the handle side plates 20, 22. U-shaped compression springs 60 have their opposite ends connected, respectively, to a cross pin 62 and the actuating buttons 56 at opposite sides of the locking link 52. Such springs 60 bias the link to a forward swung position, toward the tang 40. The springs can be nested in recesses 63 in the inside surfaces of the handle side plates 20, 22 so as not to interfere with swinging of the blade.

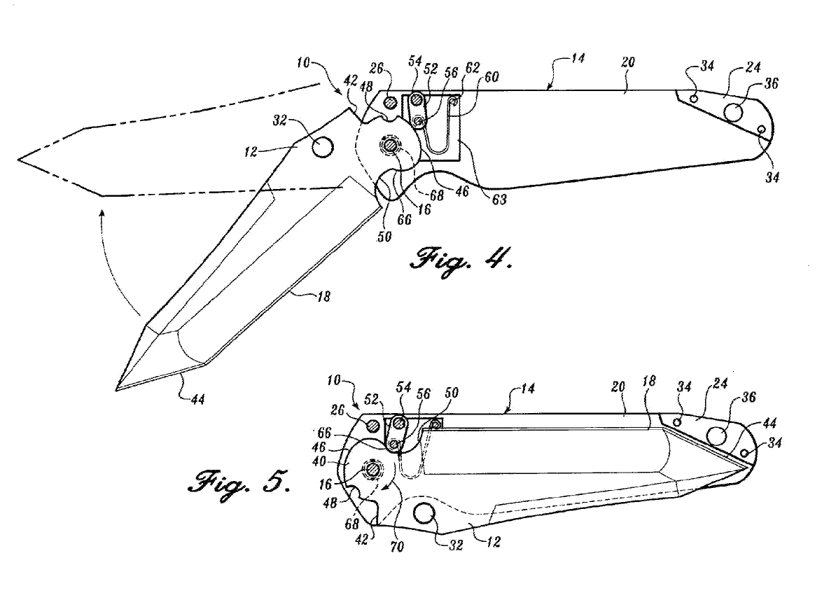

With reference to FIG. 3, in the open position of the blade 12, the arcuate bottom end portion of the locking link 52 fits in the notch 48. Preferably, the notch is substantially semicircular and complemental to the shape of the bottom end of the link. In such position, swinging of the knife blade 12 relative to the handle 14 is prevented by engagement of the notched tang against the bottom end portion of the locking link 52. Force applied to the top of the blade in a closing direction is transmitted by way of notch 48 in an upward direction, generally lengthwise of the link toward its pivot pin 54. To release the blade, the user need only press rearward on either of the operating buttons 56, thereby swinging the link to a position in which its bottom end portion is no longer engaged in the notch 48. The blade then can be swung to its closed position, through the position of FIG. 4 to the position of FIG. 5. Releasing the lock by manipulation of one of the buttons is accomplished conveniently and safely because the user's hand typically will lie over the top of the handle 14 and neither the fingers nor hand need to be placed or are encouraged to be placed over the bottom opening of the handle slot 27, in a location where the sharpened edge 18 of the blade would engage them.

In this embodiment, the notch or contoured portion 50 at the opposite side of the tang from notch 48 receives the swinging end portion of the locking link 52 when the knife is in the closed position shown in FIG. 5. However, the recess 50 is shaped such that the swinging end of link 52 engages against an abrupt, more sharply curved portion 66 of the periphery of the blade tang 40. Thus, the blade is positively biased toward the closed position by the link 52.

In addition, mechanism is provided to bias the blade toward the open position. In the embodiment of FIGS. 1-5, this element is a spiral spring 68 encircling the pivot pin 16. One end of the spring is attached to the blade, and the other end of the spring is attached to the adjacent handle, to provide a biasing force in the direction of the arrow 70 of FIG. 5, i.e., toward the open position of the blade.

The biasing force applied by the spiral spring 68 can be approximately constant through the range of motion of the blade relative to the handle. However, any biasing force applied by the link 52 and associated springs 60 is dependent on the contour of the blade tang portion 40 engaged by the link. In the fully closed position, shown in FIG. 5, a substantial moment is created by the engagement of the link 52 against the abrupt tang portion 66, sufficient to overcome the biasing force of the spiral spring 68. However, after the blade has been moved manually toward the open position, the link rides on the central portion 46 of the tang periphery, such as in the position of FIG. 4, where only frictional forces of the tang sliding along the link resist opening of the knife blade by the action of the spiral spring 68. In the preferred embodiment, the forces are balanced such that the blade will be retained in the closed position until it has been moved manually through a predetermined angle (a point of unstable equilibrium), and after movement of the blade beyond that angle, force of the spiral spring 68 is sufficient to move the blade automatically to the open position.

Stated in another way, the action of the link 52 and associated springs 60 provides a “brake force” when the knife is in the closed position, with such force decreasing abruptly or gradually as the knife blade is moved toward the open position, until such time as the biasing force of the spiral spring overcomes the force of the link 52 and associated springs 60.

The result is a knife which need only be moved through a predetermined small angle, such as 15 to 30 degrees, before the biasing force of the spiral spring automatically swings the blade to the fully open position. The net biasing force in the closed position, and the angle of the equilibrium position, are determined by the relative strengths of the two springs and the contouring of the recess 50 adjacent to the sharpened edge 18 of the blade. From the position of FIG. 5, opening movement applied manually to the blade will swing the locking link 52 rearward against the biasing force of the springs 60 until the swinging end of the link has moved sufficiently to ride on the semicircular cam edge portion 46 of the tang 40. See, for example, the position of FIG. 4. To obtain this result, notch 50 must be gradually curved toward the tip of the blade, forming a recess within which the locking link may swing as the blade is opened.

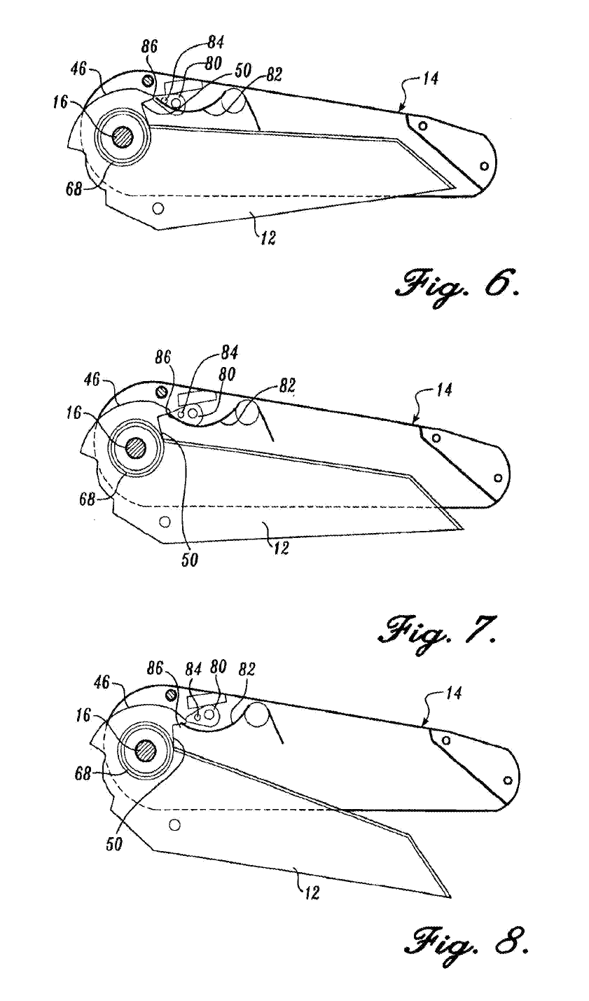

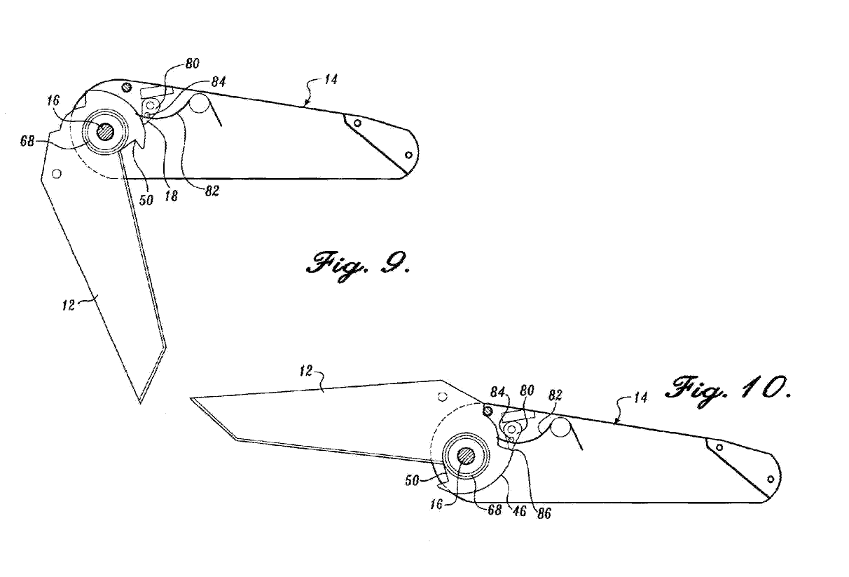

Similar to the embodiment of FIGS. 1-5, the embodiment of the invention shown in FIGS. 6-10 includes a blade 12 pivotally mounted between side plates of a handle 14 by a pivot pin 16. A force biasing the blade toward the open position is supplied by a spiral spring 68. A mechanical member in the form of a brake lever 80 is biased to the position shown in FIG. 6 by engagement of a leaf spring 82 against a pin 84 projecting transversely from the brake lever. The spring and pin are offset from the plane of the blade, including its tang portion. However, the brake lever has a projecting tip portion 86 which, in the closed position of the blade shown in FIG. 6, engages against an undercut side of a contoured notch 50 formed in the tang end portion of the blade. In the position of FIG. 6, as well as the partially opened positions of FIGS. 7 and 8, the brake lever, in combination with its biasing leaf spring, supplies a force in the closing direction sufficient to overcome the opening force supplied by the spiral spring. However, after the blade has been moved toward the open position through a predetermined angle, the notched portion of the tang moves past the tip of the brake lever so that the brake lever simply rides along the semicircular portion 46 of the tang, such as in the position of FIG. 9. In this position, the biasing force of the spiral spring overcomes any braking action of the brake lever, and the knife blade is automatically swung to the open position shown in FIG. 10.

Another aspect of the embodiment of FIGS. 6-10 is that the force applied to the brake lever differs as the lever swings because the pin 84 rides along the length of the leaf spring 82. A greater force is applied with the blade closed than with the blade partially opened because the effective length of the leaf spring decreases as the lever swings from the position shown in FIG. 6 to the position shown in FIG. 8, for example.

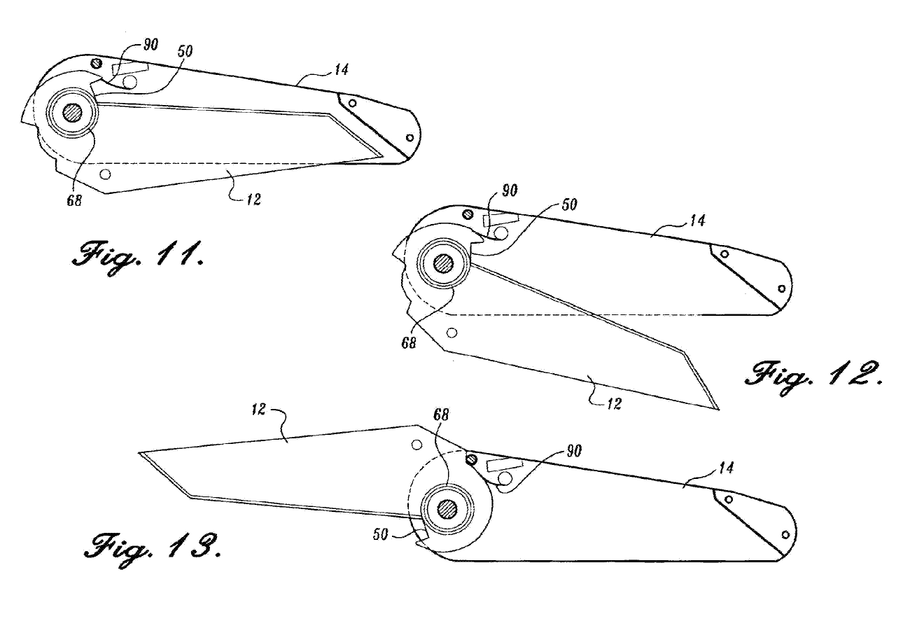

In the embodiment of FIGS. 11-13, rather than providing a brake assembly, including a lever and spring, the braking force is supplied only by a leaf spring 90. In the closed position (FIG. 11) the tip of the leaf spring engages against the notched portion 50 of the blade tang. When the blade is partially opened, such as to the position of FIG. 12, the tip of the leaf spring is moved past the notched portion of the tang, and the force of the spiral spring 68 will automatically swing the blade to the open position.

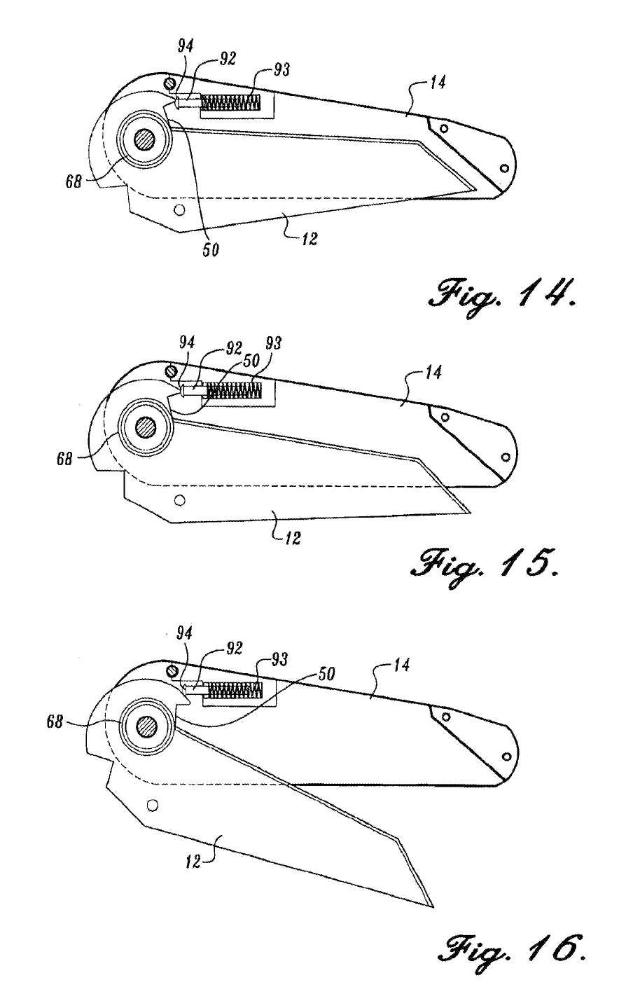

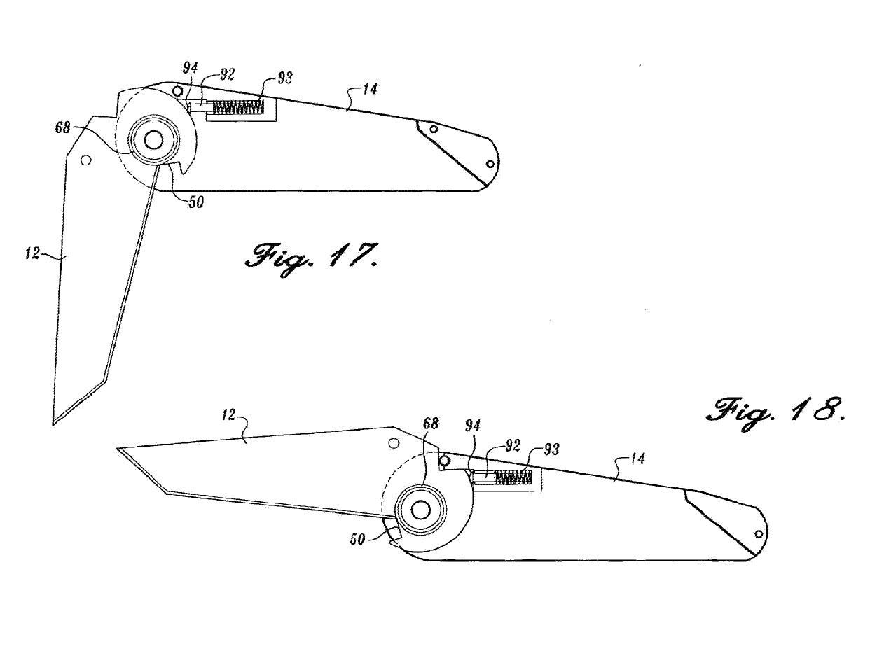

In the embodiment of FIGS. 14-18, the brake force is supplied by a mechanical member in the form of a spring-loaded plunger 92 mounted between the side plates of the handle 14 and biased by a helical compression spring 93. The plunger has a rounded tip 94 which, in the closed position of the blade shown in FIG. 14, supplies a substantial force resisting opening movement of the blade 12 by engagement against a side of the notch 50. When the blade is partially opened, such as is shown in FIG. 15, the notched portion of the tang of the blade moves into alignment with the spring-loaded plunger, which determines the equilibrium position. As the blade is swung more toward the open position, such as the position shown in FIG. 16, the brake force supplied by the spring-loaded plunger is not sufficient to overcome the biasing force of the spiral spring 68, and the blade is automatically swung to the open position, through the position of FIG. 17 to the position of FIG. 18.

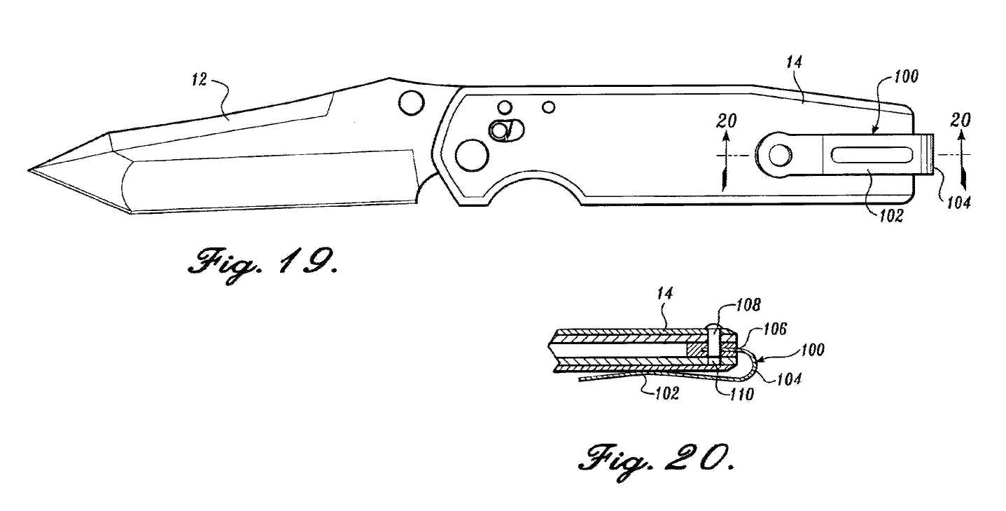

With reference to FIGS. 19 and 20, it can be convenient to provide a spring clip 100 on the end of the handle 14 remote from the blade pivot, for attaching the knife to an object, such as a belt, bag, pocket, visor, and so on. The clip illustrated includes a long spring arm 102 extending along one of the handle side plates, a return bent portion 104, and an opposite end portion 106 fittable into a slot in the rear end of the handle. For example, the slot may be formed in the spacer between the knife side plates. The end portion 106 of the clip received in the slot has a hole for a threaded fastener 108 that can be inserted through a bore 110 aligned with the slot. One advantage of the construction illustrated is that, with the fastener removed, the clip can be detached from the handle and rotated into a position for use with the opposite side. Thus, the orientation of the clip can be customized based on the preference of the user.

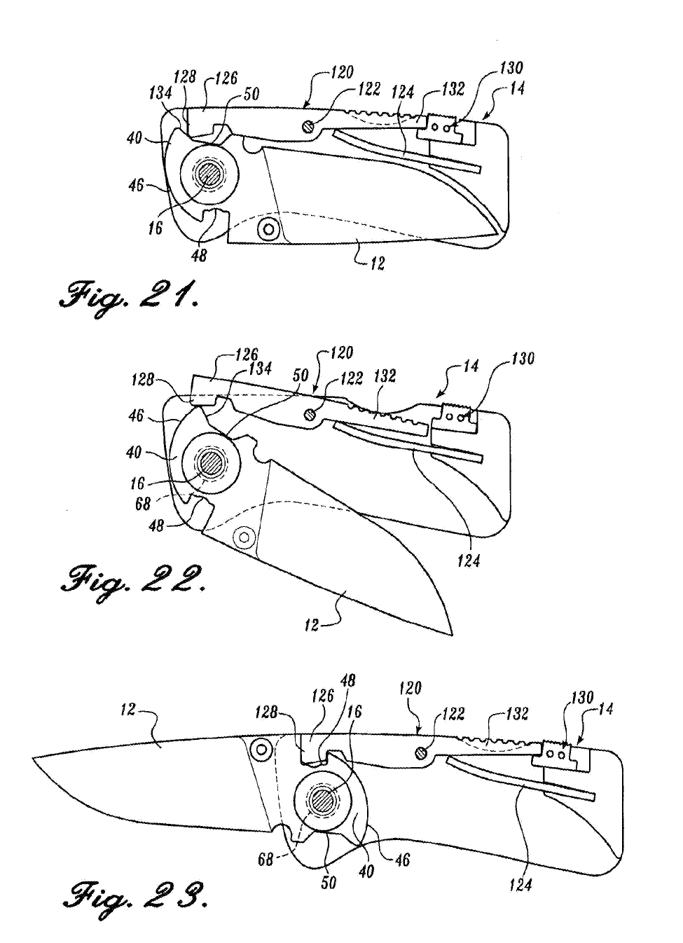

In the embodiment of FIGS. 21-23 the blade 12 rotates about the axis of the pivot 16 relative to a handle 14 between the closed position shown in FIG. 21 and the open position shown in FIG. 23. FIG. 22 shows an intermediate position. A mechanical member in the form of a biasing and locking lever 120 is received between opposite sides of the handle and is mounted for rotation about a pivot 122. A leaf spring 124 biases the lever 120 such that a leading end portion 126 of the lever is urged downward toward the tang 40 of the blade. The leading portion 126 has a hooked end 128 that fits within a locking notch 48 in the tang when the blade is in the open position, as seen in FIG. 23. A sliding safety mechanism 130 (described in more detail below with reference to FIG. 30, for example) fits against a trailing portion 132 of the lever and must be moved rearward to free the lever such that it can be rotated by manually pressing downward on trailing portion 132 to lift the hooked end 128 from the locking notch 48, whereupon the blade can be moved toward the closed position against the biasing force of the spiral spring 68. Similarly, mechanism 130 can be moved when the blade is closed. FIG. 21 shows the safety in the blade-locking position which prevents opening movement of the blade. From that position the safety can be manually moved rearward to permit swinging of the lever 120 and opening of the blade.

In the closed position of the blade 12, the hooked end 128 of lever 120 fits within a contoured notch 50 of the tang 40. The nose of the hooked end 128 is biased into engagement against an inclined portion 134 of the notch. The biasing force of the spring 124 is sufficient that with the blade in the closed position, the hooked end 128 applies a “braking force” sufficient to overcome the opening force of the spring 68. However, the blade can be moved manually from the closed position of FIG. 21, through the partially open position of FIG. 22, with the effect of wedging the leading portion 126 of lever 120 upward and outward as the blade rotates. Eventually, the blade reaches a position where the hooked end 128 of lever 120 rides on the generally semicircular portion 46 of the tang 40. At this point, the lever 120 does not apply sufficient braking force to overcome the opening force of the spiral spring 68, and the blade will automatically swing to the open position shown in FIG. 23.

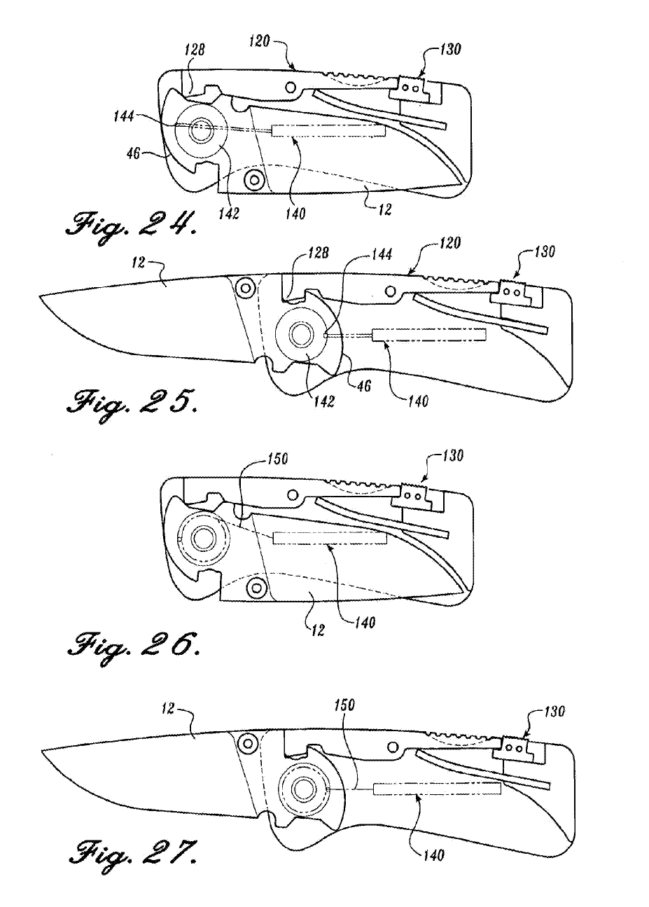

The embodiment of FIGS. 24 and 25 is the same as the embodiment of FIGS. 21 and 23, except for the elements applying the constant opening force to the blade 12. In the embodiment of FIGS. 24 and 25, a tension spring assembly 140 is used. The tension spring assembly is shown diagrammatically, and connects to a hub portion 142 of the blade. The net moment applied by the tension spring assembly depends on the angular position of the blade. For example, in the closed position of the blade illustrated in FIG. 24, the rotational force applied by the tension spring assembly is quite small, whereas the net opening force applied increases as the blade is swung toward the open position and the connection point 144 of the tension assembly moves. As in the other embodiments, the braking force applied when the blade is closed is sufficient to overcome the opening force, but when the blade has been swung through a predetermined angle toward the open position, such as when the hooked end 128 of the lever 120 rides on the semicircular portion 46 of the blade tang, the opening force is greater than the braking force and the blade will be swung automatically to the open position.

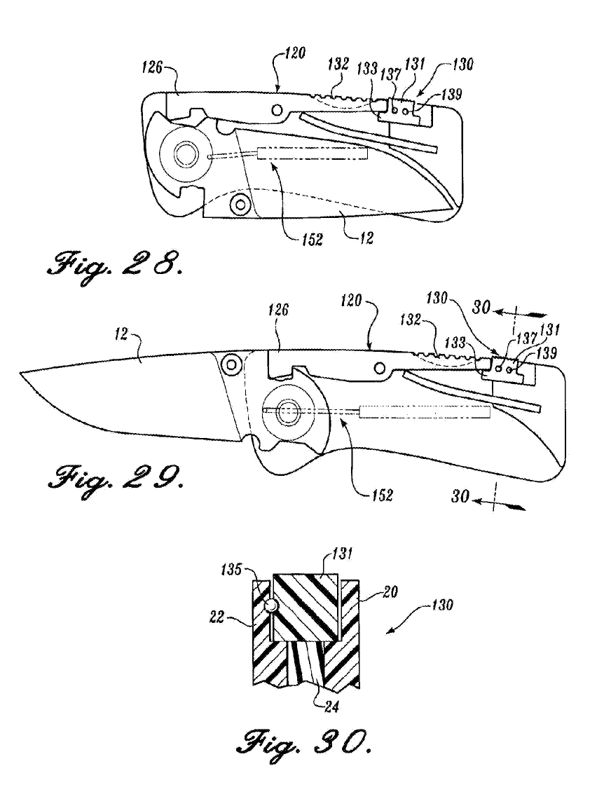

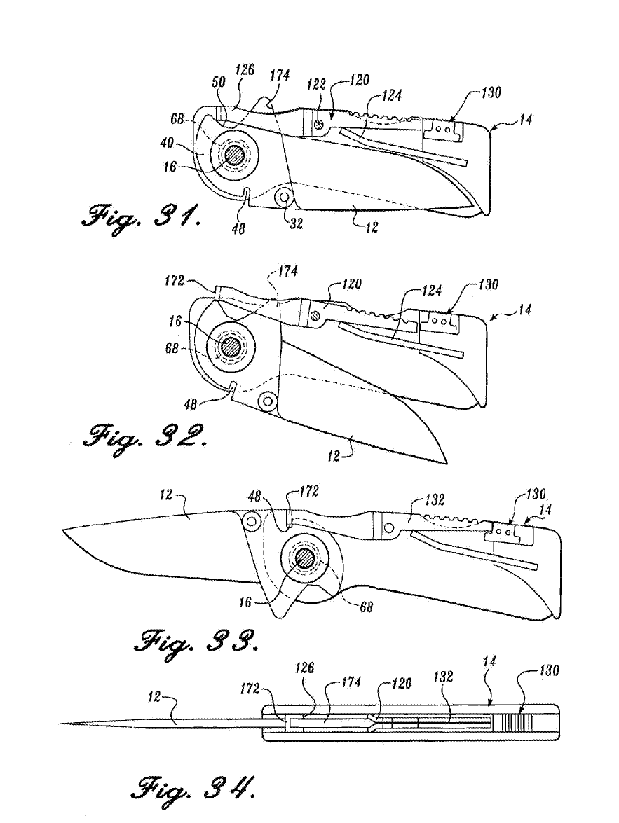

Similarly, in the embodiment of FIGS. 26 and 27 a modified form of tension spring assembly 140 is used, including a flexible wire segment 150 which, in the closed position of the blade 12 (FIG. 26), extends around the hub of the blade (like a pulley). The spring is located within a housing for pulling on the wire in a direction tending to rotate the blade toward the open position. FIGS. 28 and 29 show a similar embodiment using a compression spring assembly 152. In all cases, the member, component or assembly biasing the blade open does not exert a force sufficient to overcome a braking force applied by another member, component or assembly when the blade is in the closed position, but the braking force is insufficient to overcome the opening force after the blade has been moved manually through a predetermined angle from the closed position toward the open position.

Each of the embodiments of FIGS. 21-23, FIGS. 24-25, FIGS. 26-27 and FIGS. 28-29 have the safety mechanism 130 which can be used to selectively block movement of a lever 120 such that inadvertent movement of the blade from the closed position or from the open position is prevented. For example, if a knife having assisted opening is carried in a pocket in the closed position, the thumb bob could conceivably catch or snag as the knife is removed. This could result in partial opening of the blade to the point where the opening mechanism takes control and swings the blade to the fully open position unintentionally. With reference to FIG. 30, the safety mechanism 130 includes a block 131 slideable fore and aft along a notch or shoulder formed in the handle, such as in the spacer 24 and the handle side plates 20, 22. As seen in FIGS. 28 and 29, for example, the leading end of the block 131 forms a projection 133 that fits under the trailing end portion 132 of the lever 120, blocking swinging movement of the lever in a direction to lift the leading end portion 126 away from the tang of the blade 12. The lever can be released by manually sliding the safety block rearward. Preferably a detent mechanism is provided to hold the block in its forward or rearward slid position. With reference to FIG. 30, the detent mechanism can include a ball 135 fitted in a socket of one of the handle side plates. The ball engages a depression 137 or 139 in a side of the block 131 depending on whether the block is in its forward (safety on) or rearward (safety off) position.

The embodiment shown in FIGS. 31-35 has many of the features of the embodiment of FIGS. 21-23. Blade 12 rotates relative to a handle 14 about the axis of a pivot pin 16. A mechanical member in the form of a locking lever 120 extends along the top of the handle and swings about a pivot 122. A leaf spring 124 carried by the handle biases the lever 120 such that the leading end portion 126 is biased downward toward the tang 40 of the blade. The safety mechanism 130 can be actuated to block swinging movement of the lock lever 120. In the closed position of the blade (FIG. 31), the forward portion 126 of the lock lever fits in a contoured notch 50 of the tang such that, with the safety 130 released, the blade can be manually swung toward the open position, wedging the leading end 126 of lever 120 upward against the biasing force of the leaf spring 124. When the blade has been swung through a predetermined angle, slightly beyond the position shown in FIG. 32, the biasing force of an opening spring, depicted diagrammatically as a spiral spring 68, is sufficient to overcome any braking force achieved by the assembly of spring 124 and lever 120. From the predetermined angular position, the blade 12 is automatically swung open to the position of FIG. 33 by the action of the opening spring 68. Other mechanisms for biasing the blade to the open position can be used.

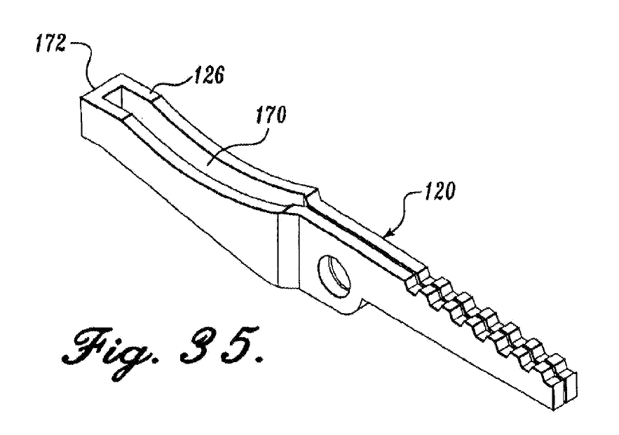

As best seen in FIGS. 34 and 35, the locking lever 120 is formed with a central opening 170 along the leading end portion 126. The leading tip 172 of the lever 120 spans between opposite sides of the opening 170. The width of the opening 170 is sufficient for receiving a projecting portion 174 of the blade tang, generally opposite the thumb bob 32, as seen in FIG. 31. In the closed position of the knife, the projecting portion 174 of the tang extends through the central opening of the lever 120. Preferably the projection 174 is blunt, such that a user may press downward on it, thereby causing the blade to swing from the closed position toward the open position, as seen in FIG. 32. At this position the closing force of the brake mechanism is overcome and the blade automatically swings to the open position shown in FIG. 33 due to the biasing force of the opening spring 68. The end portion 172 of the lever fits into the blade locking slot 48 such that the blade is held open until, with the safety released, the trailing end portion 132 of the lever 120 can be depressed to release the blade for manual swinging back to the closed position, against the biasing force of the opening spring 68.

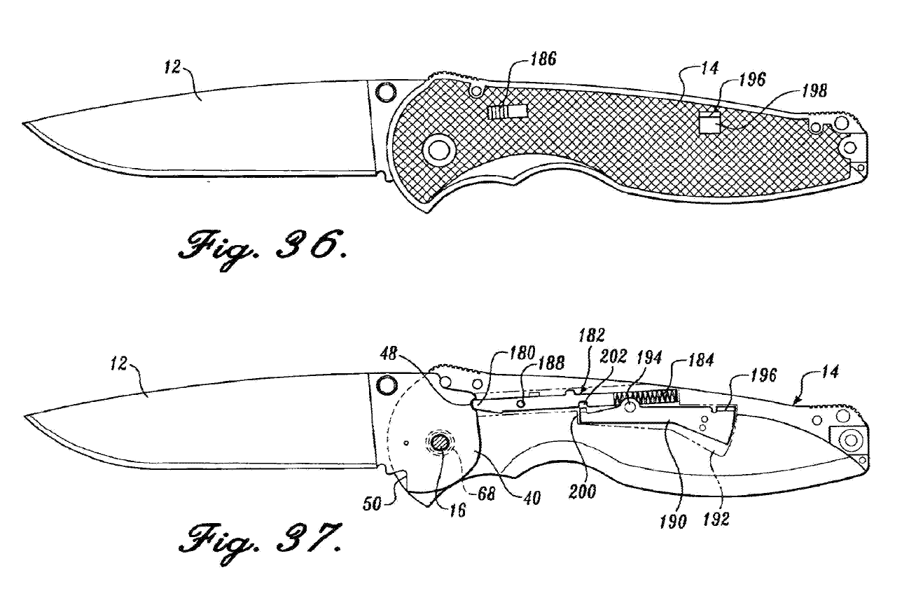

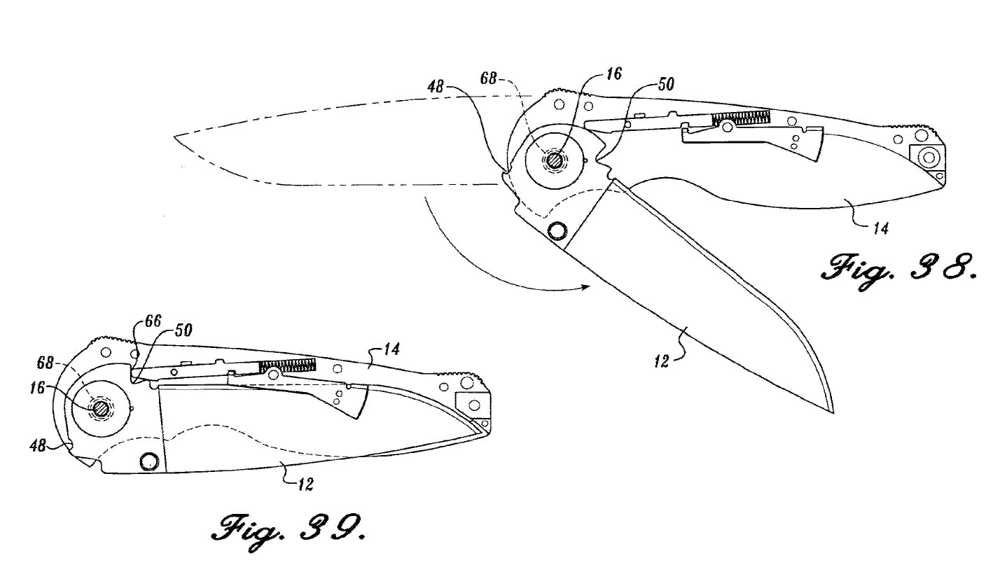

In the embodiment of FIGS. 36-39, a different type of mechanical blade braking and blade locking member is used. As in the other embodiments, a blade 12 is pivotally mounted on a handle 14 by a pivot 16. The tang 40 of the blade has a notch 48 for reception of the nose 180 of a plunger mechanism 182 when the blade is in the open position. The plunger mechanism 182 is biased forward, toward the tang of the blade, by a helical compression spring 184. The plunger can be fitted in an elongated channel formed in the handle 14, in the same plane as the blade 12 and its tang 40. An operating button 186 (FIG. 36) connects to the plunger 182, such as by an internal pin 188 (FIG. 37), such that the plunger can be refracted to release the blade by manipulation of the button 186 from the exterior of the handle 14.

A safety mechanism is provided to selectively lock the plunger in the extended position, thereby preventing unlocking of the blade. When the safety is released, retraction of the plunger is permitted for unlocking the blade and moving it to the closed position. In this embodiment, the safety mechanism includes a swinging lever 190, most of which is received in a cavity 192 of one of the handles. The lever swings on a pivot 194. At the trailing end of the lever, a tab 196 projects outward through a slot 198 of the handle (FIG. 36). At the leading end, a tab 200 projects inward, beneath the plunger 182. Tab 200 is in position to register with a notch 202 of the plunger when the plunger is in the extended position, such as when its nose 180 is engaged in the locking notch 48 of the blade. Preferably a detent mechanism is provided, similar to that described with reference to FIG. 30, to retain the safety lever in its “safety on” or “safety off” position.

With the safety off, the plunger can be retracted by operation of the button 186 as described above, whereupon the knife blade 12 can be moved toward the closed position, against the biasing force of the opening spring 68. The nose of the plunger rides along the smooth portion of the blade tang 40 as the blade is pivoted to the closed position. When the blade reaches the closed position, or close to it, the plunger fits in the contoured recess 50 and acts against the abrupt side 66 of the recess, as seen in FIG. 39. In this position, the plunger applies a stronger closing force on the blade, sufficient to overcome the force of the opening spring. In addition, the plunger is extended in this position, such that the safety may be actuated to prevent retraction of the plunger. This prevents movement of the blade toward the open position unless the safety is released.

In the opposite direction, the safety is released to permit retraction of the plunger by opening of the blade. When the blade is in or near its closed position, the force of the plunger against the abrupt side 66 of the contoured notch 50 is sufficient to overcome the force of the opening spring 68. Consequently, the blade is biased closed. When the blade is moved through a predetermined angle, the plunger clears the notch and the opening spring will cause the blade to swing to its open position.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A knife having a longitudinal axis and comprising:
a. a handle having first and second side portions, the handle having a surface defining a groove;
b. a surface defining at least one slot in the longitudinal rearward portion of the handle;
c. a blade attached to the handle at a longitudinally forward portion of the handle, the blade having an open orientation and a closed orientation where when in a closed orientation the blade is configured to be positioned within the groove of the handle;
d. a spring clip removably attached to an end portion of the handle, the spring clip having a base region operatively configured to fit within the slot in the longitudinal rearward portion of the handle where an end portion of the spring clip can be positioned adjacent to either the first or second side portions of the handle by way of removing the base portion from the slot and repositioning the spring clip substantially 180° about a longitudinal axis of the knife and positioning the base portion within the slot of the handle.

2. The knife recited in claim 1 where the slot is formed in a spacer between two side plates positioned at first and second lateral side portions of the handle,

3. The knife recited in claim 1 where a first end of the clip is configured to receive a threaded fastener to be inserted through a surface defining a bore in the handle in communication with the slot.

4. The knife recited in claim 1 where a base portion is substantially rectangular along the longitudinal axis of the knife and the surface defining the slot is substantially rectangular and configured to receive the base portion.

5. A folding knife comprising:
a. a handle having first and second side surfaces and a rear surface positioned in a rearward portion of the handle connecting the first and second side surfaces;
b. a clip attachment location positioned rearward portion of the handle adjacent to the rear surface;
c. a blade attached to the handle at a longitudinally forward portion of the handle, the blade having an open orientation and a closed orientation where when in a closed orientation the blade is configured to be positioned within the handle;
d. a clip removably attached to the clip attachment location of the handle remote from the blade, the spring clip having a base region operatively configured to fit within the clip attachment location of the handle where an end portion of the spring clip can be positioned adjacent to either the first or second side portions of the handle by way of removing the base portion from the clip attachment location and repositioning the spring clip substantially 180° about a longitudinal axis of the handle.

6. The folding knife as recited in claim 5 where the clip attachment location comprises a longitudinally extending slot where the base region of the clip extends therein.

7. The folding knife as recited in claim 5 where a screw extends in a lateral direction to hold the spring clip at the base region to fixedly and removably attach it to the handle where an end portion is either on the first or second side portions of the handle.

8. The folding knife as recited in claim 5 where the attachment location comprises at least one slot to position the base region of the spring clip in a manner so the end portion of the spring clip is adjacent to only the first side portion of the handle.

9. The folding knife as recited in claim 5 where the blade is rotatably attached to the handle.

10. An automatic opening folding knife to allow the knife to open automatically or by way of assisted opening, the folding knife comprising:
a. a handle having a front end portion and a rear end portion, the handle having an internal surface defining an internal cavity.
b. a blade having a sharpened edge and a blade tang at a first end of the blade, the blade being pivotally attached at the first end to the front end portion of the handle, the blade tang having a recess and a tang periphery, the recess having an inward indentation with respect to the tang periphery;
c. an engagement member movably attached at the front and portion of the handle where the engagement member is operatively configured to engage the blade tang, the engagement member is biasedly configured to engage the recess of the blade tang when the blade is in a closed orientation with respect to the handle;
d. a biasing force member operatively attached to the blade to bias the blade from the closed orientation to an open orientation,
e. whereas the engagement member biasedly engages the recess of the blade tang, thereby creating a sufficient degree of force to resist the opening force of the biasing force member to maintain the blade in the closed orientation with respect to the handle, and when the engagement member is repositioned to disengage the recess of the blade tang the biasing force member repositions the blade to the open orientation, and alternatively, when the blade is repositioned from the closed orientation to a predetermined angle, the biasing force member overcomes the counteracting force of the engagement member engaging the recess, thereby further forcefully repositioning the blade to the open orientation.

11. The automatic opening folding knife as recited in claim 10 where the biasing force member is a spiral spring having a first end attached to the blade and a second end attached to the handle.

12. The automatic opening folding knife as recited in claim 11 where the spiral spring provides a torque to open the blade regardless of the orientation of the blade with respect to the handle.

13. The automatic opening folding knife as recited in claim 10 where the engagement member is configured to slidably engage the tang periphery and the frictional force between the tang periphery and the engagement member is insufficient to overcome the opening force of the biasing force member.

14. The automatic opening folding knife as recited in claim 10 where the engagement member is pivotally attached at a portion of the handle which is near the sharpened edge portion of the blade when the blade is in the closed orientation with respect to the handle.

15. The automatic opening folding knife as recited in claim 10 where the engagement member is a brake lever rotatably attached to the handle where the brake lever comprises a tip portion configured to engage the recess.

16. An automatic opening knife comprising:
a. a handle having a front end portion and a rear end portion, the handle having an internal surface defining an internal cavity.
b. a blade having a sharpened edge and a blade tang at a first end of the blade, the blade being pivotally attached at the first end to the front end portion of the handle, the blade tang having a recess and a tang periphery, the recess having an inward indentation with respect to the tang periphery and a lock notch is provided in the blade tang which is an inward indentation with respect to the tang periphery;
c. a biasing force member operatively attached to the blade to bias the blade from the closed orientation to an open orientation
d. an engagement member movably attached at the front and portion of the handle where the engagement member is operatively configured to biasedly engage the recess of the blade tang when the blade is in a closed orientation with respect to the handle to maintain the blade in a closed orientation thereby creating a sufficient degree of force to resist the opening force of the biasing force member to maintain the blade in the closed orientation with respect to the handle and when the engagement member is repositioned to disengage the recess of the blade tang the biasing force member repositions the blade to the open orientation and the engagement member further engages the lock notch of the blade tang when the blade is in an open position with respect to the handle.

17. The automatic opening knife as recited in claim 16 where the engagement member must be disengaged from the lock notch when the blade is in the open position with respect to the handle so the blade can reposition to a closed position.

18. The automatic opening knife recited in claim 16 where when the blade is repositioned from an open position to a closed position, the biasing force member is placed in a higher energy state to force the blade to the open position when the engagement member disengages from the recess of the blade tang.

19. An automatic opening knife comprising:
a. a handle having a front end portion and a rear end portion, the handle having an internal surface defining an internal cavity.
b. a blade having a sharpened edge and a blade tang at a first end of the blade, the blade being pivotally attached at the first end to the front end portion of the handle;
c. a biasing force member operatively attached to the blade to bias the blade from the closed orientation to an open orientation;
d. an engagement member movably attached at the front and portion of the handle where the engagement member is operatively configured to biasedly engage the blade when the blade is in a closed orientation with respect to the handle to maintain the blade in a closed orientation thereby creating a force to resist the opening force of the biasing force member to maintain the blade in the closed orientation with respect to the handle and when the engagement member is repositioned to disengage the blade the biasing force member repositions the blade to the open orientation, alternatively when the blade is repositioned from the closed orientation to a predetermined angle, the biasing force member overcomes a counteracting force thereby further forcefully repositioning the blade to the open orientation.

20. A folding knife comprising:
a. a blade having a pivot attachment region and a sharpened edge, a tang portion positioned near the pivot attachment region of the blade, the tang portion having a locking notch and a contoured notch,
b. a handle having a pivot portion pivotally attaching the handle to the blade at a forward location,
c. a lever received between opposite sides of the handle and mounted for rotation about a lever pivot, the lever having a leading portion and a trailing portion, a biasing member biasing the lever where the leading edge portion is urged toward the tang of the knife, the leading edge portion configured to engage the locking notch of the tang portion of the blade when the blade is in an open orientation and the leading edge portion is configured to engage the contoured notch of the tang portion of the blade when the blade is in the closed orientation with respect to the handle,
d. a mechanism having a first and second position were the mechanism is configured to engage the trailing portion of the lever inhibiting rotation thereof, thereby maintaining engagement of the leading portion of the lever with either the locking notch or contoured notch of the tang of the blade to maintain the blade in either an open orientation or a closed orientation respectively.

21. The folding locking blade as recited in claim 20 where a blade biasing component is connected between the blade and the handle providing a force upon the blade to bias the blade from the closed orientation to the open orientation.

22. The folding locking blade as recited in claim 21 where the leading portion of the lever while engaging the contoured notch of the tang provides a counteracting rotational force upon the blade with respect to a force produced by the blade biasing component whereby when the blade rotates beyond a prescribed degree of rotation with respect to the handle, the force from the blade biasing component is greater than the force applied between the leading end portion of the lever engaging the contoured notch such that the force of the blade biasing component is sufficient to swing the blade automatically toward the open orientation.

23. The folding locking blade as recited in claim 22 where the blade has a projection portion and the locking lever has a surface defining an opening near the leading end portion whereby when the blade is in the closed orientation, the projecting portion extends therebetween and is interposed in the surface defining the opening of the leading end portion and the projecting portion extends fully therethrough.

24. The folding locking blade as recited in claim 23 where the projecting portion is configured to be pressed, thereby repositioning the blade beyond an equilibrium point where the force of the blade biasing component is greater than the counteracting force of the interaction between the leading end portion and the contoured notch.

25. A folding knife comprising:
a. a blade having a pivot attachment region and a sharpened edge, a tang portion positioned near the pivot attachment region of the blade, the tang portion having a locking indentation,
b. a handle having a pivot portion pivotally attaching the handle to the blade at a forward location,
c. a tang engaging member movable attached to the handle, the tang engaging member having a leading portion and a trailing portion, a biasing member biasing the tang engaging member where the leading edge portion is urged toward the tang of the knife, the leading edge portion configured to engage the locking indentation of the tang portion of the blade when the blade is in an open orientation, and
d. a mechanism having a first and second position were the mechanism is configured to engage the tang engaging member inhibiting movement thereof, thereby maintaining engagement of the leading portion of the tang engaging member with the locking indentation when the knife is in an open orientation to lock the knife open.

26. The folding knife as recited in 25 where the tang engaging member is a spring back bar.

27. The folding knife as recited in 25 where the leading edge portion is configured to engage a contoured notch of the tang portion of the blade when the blade is in the closed orientation with respect to the handle.

28. The folding knife as recited in 27 where either the tang engaging member engages either the locking indentation or contoured notch of the tang of the blade to lock the blade in either an open orientation or a closed orientation respectively.

29. A folding knife to lock a blade in either on open position or a closed position, the folding knife comprising:
a. a handle member having a forward region with a pivot attachment location and a rearward region,
b. a blade pivotally attached at the pivot attachment location of the blade, the blade having a tang portion comprising a locking notch and a contoured recess,
c. a lock member movably attached to the handle, the lock member having a tang engagement portion,
d. a biasing member which is configured to bias the tang engagement portion toward the tang of the blade, the lock member further comprising a notch portion,
e. a mechanism comprising a lever movably attached to the handle, the lever comprising a tab configured to engage the notch of the lock member when the lever is in a locked position, the tab of the lever being operatively positioned to engage the notch of the lock member either when the tang engagement portion is engaging the locking notch of the blade when the blade in an open position, or when the tang engagement portion of the lock member is engaged to the contoured recess of the blade when the blade is in a closed position whereby when the tab is an engagement with the notch of the lock member, the blade is either maintained in a open or closed orientation respectively.

30. The folding knife as recited in claim 29 where the tab engagement portion is a nose, and the lock member is slidably attached to the handle.

31. The folding knife as recited in claim 30 where the lever is pivotally attached to the handle and the lateral extension extends through a surface defining an opening of the handle to reposition the tab to and from the notch of the lock member when the blade is either in the open or closed position.

32. The folding knife as recited in claim 31 whereby when the lever is positioned so the tab of the lever is disengaged from the notch of the lock member, a coloration is displayed through the opening of the handle providing access to the lateral extension of the lever.

33. A folding knife comprising:
a. a handle having a front end portion and a rear end portion,
b. a blade having a sharpened edge and a tang, the blade pivotally attached to the front end portion of the handle and being configured to be positioned in an open position where the sharpened edge is exposed for use and a closed position in which the sharpened edge is received by the handle, the blade having a projecting point near a base portion of the blade, the blade having a tang portion with a locking notch,
c. a locking lever having a surface defining a central opening along a lead portion, the projecting point of the blade configured to extend through the opening at the leading end portion when the blade is in a closed orientation, the locking lever having a leading tip configured to engage the locking notch of the tang portion of the blade when the blade is in the open position, the locking lever having a trailing end portion configured to be repositioned towards the handle, thereby disengaging the leading tip from the locking notch of the tang portion to unlock the blade from the open position to allow the blade to reposition to the closed position.

34. The folding knife as recited in claim 33 where the leading tip is further configured to engage a contoured notch of the tang portion of the blade when the blade is in the closed position with respect to the handle.

35. The folding knife as recited in claim 34 where the engagement of the leading tip with the contoured notch creates a first torquing moment, biasing the blade to a closed orientation when the blade his in the closed position and a blade biasing component is operatively attached between the blade and the handle to bias the blade to an open orientation where the amount of rotational torque upon the blade is insufficient to open the blade when the blade is in a closed position and the leading tip is engaging the contoured notch of the tang of the blade, and when the blade is opened to a prescribed amount of rotation, the leading tip is rotated past the contoured notch of the blade and the blade is biased to the open position.

36. A knife comprising:
a. a handle having a front end portion and a rear end portion, the handle having a surface defining a blade retaining recess,
b. a blade having a sharpened edge, a tang having a tang cam edge, the tang pivotally attached to the front end portion of the handle for repositioning the blade between an open position where the blade extends from the handle and a closed position where the sharpened edge is received within the blade retaining recess of the handle, the blade having a projecting portion of the tang which is positioned on the longitudinal side of the blade adjacent to the edge portion,
c. a lever pivotally attached to the handle at the rear portion, the lever having first and second lateral regions defining a central opening, the lever having a leading tip which is configured to engage the tang cam edge where when the blade is in the open position with respect to the handle, the leading tip of the lever is in engagement with the tang cam edge,
d. whereas the projected portion of the blade is configured to extend through the opening of the lever so the projected portion is exposed for manipulation from the rearward portion of the handle.

37. The knife as recited in claim 36 where the trailing end portion is positioned at an opposing region of the lever of the leading tip and a pivot is interposed therebetween.

38. The knife as recited in claim 36 where the tang cam edge comprising a locking recess where when the blade is in the open position with respect to the handle, the leading tip of the lever is in engagement with the locking recess of the tang cam edge.

39. The knife as recited in claim 36 where the leading tip is operatively configured to engage the tang edge at a recess portion where a spring member biases the leading tip toward the recess portion creating a torquing force to close the knife when the blade is in a closed position with respect to the handle, a blade biasing component is connected between the blade and the handle to provide a force to reposition the blade from the closed position to the open position where the force of the blade biasing component upon the blade is greater than the closing force of the leading tip when engaging the recess portion at a predetermined angel of the blade with respect to the handle.
